(19) United States
(12) Patent Application Publication
(10) Pub. No.: US 2010/0262363 A1
(43) Pub. Date: Oct. 14, 2010

(54) Human-Machine Interface Apparatus

(76) Inventors: Cheng-Jan CHI, Taipei (TW); Ren-Chyuan Luo, Taipei (TW); Chun-Chi Lai, Taipei (TW)

Correspondence Address: LanWay IPR Services, P.O. Box 220746, Chantilly, VA, 20153, US

(21) Appl. No.: 12/500,806

(22) Filed: Jul. 10, 2009

(30) Foreign Application Priority Data
Apr. 13, 2009 (TW) 098112242

(51) Int. Cl. G01C 21/00

(52) U.S. Cl. 701/207

(57) ABSTRACT

A human-machine interface apparatus configured for providing navigation information to users according to data from a positioning system, is provided. The human-machine interface apparatus comprises a pointing module and a microcontroller unit. The pointing module has a pointer. The microcontroller unit is electrically connected with the pointing module, and is configured for receiving information of a destination generated from the positioning system and controlling the pointing module according to the information of the destination, to keep the pointer pointing to an actual position of the destination after navigation is ended.

### CROSS-REFERENCE TO RELATED APPLICATIONS

This application is based upon and claims the benefit of priority from the prior Taiwanese Patent Application No. 098112242, filed Apr. 13, 2009, the entire contents of which are incorporated herein by reference.

### BACKGROUND

1. Field of the Invention

The present invention relates to a human-machine interface (HMI) apparatus for navigation, and more particularly to a human-machine interface apparatus which is intuitional in use and has a navigation capability.

2. Description of the Related Art

In recent years, vehicle-mounted satellite global positioning navigation systems are used widely. The systems are communicated with satellites to obtain three-dimensional coordinates where they are located in real time, and provide navigation information to users according to the three-dimensional coordinates. Compared with conventional maps for navigation, the satellite global positioning navigation systems can solve a problem that the users cannot accurately obtain their positions where the users are located, thus the systems are very popular.

Current vehicle-mounted satellite global positioning navigation systems on the market mostly include a screen configured for displaying the present positions of the users in a map, and recommending running routes and directions according to a destination inputted in advance by the users. When the users (generally being drivers) employ the systems, the users must transfer their visual lines from the front to the screen, and map the recommended routes and directions displayed in the map of the screen to actual roads in brains thereof. Thus the systems are not only inconvenient, but also distractive to the drivers, and there are safety potentials in driving.

Some vehicle-mounted satellite global positioning navigation systems have a voice hinting function, which plays corresponding voices when the drivers perform some operations, such as swerving, selecting roads, etc. However, the navigation of the voice hinting function is not enough intuitional for the drivers. For example, the navigation systems may hint ┌go to the destination along a 45 degree angle in front of the right┘ in voices, but the drivers still need perform certain visual-searching actions. Thus the systems are still not enough intuitional. Furthermore, the voices may disturb recumbent passengers in the vehicles, and influence the comfort degree of the passengers in the vehicles.

### BRIEF SUMMARY

The present invention relates to a human-machine interface apparatus with a navigation function, which can intuitionally transmit navigation information, be convenient and comfort in use.

A human-machine interface apparatus in accordance with an exemplary embodiment of the present invention is provided. The human-machine interface apparatus is configured for providing navigation information to users according to data from a positioning system. The human-machine interface apparatus comprises a pointing module and a microcontroller unit. The pointing module has a pointer. The microcontroller unit is electrically connected with the pointing module, and is configured for receiving information of a destination generated from the positioning system and controlling the pointing module according to the information of the destination, to keep the pointer pointing to an actual position of the destination after a navigation is ended.

From another point of view, a human-machine interface apparatus in accordance with another exemplary embodiment of the present invention is provided. The human-machine interface apparatus is configured for providing navigation information to users according to data from a positioning system. The human-machine interface apparatus comprises a pointing module and a microcontroller unit. The pointing module has a pointer. The microcontroller unit is electrically connected with the pointing module, and is configured for receiving information of a destination and controlling the pointer according to the information of the destination, to only employ the pointer of the pointing module to perform a navigation operation without displaying a corresponding map.

From other point of view, a human-machine interface apparatus in accordance with other exemplary embodiment of the present invention is provided. The human-machine interface apparatus is configured for providing navigation information to users according to data from a positioning system. The human-machine interface apparatus comprises a pointing module and a microcontroller unit. The pointing module has a pointer. The microcontroller unit is electrically connected with the pointing module, and is configured for receiving information generated from the positioning system and controlling the pointing module to guide a direction of visual lines of a driver.

The present invention employs the microcontroller unit to control a motor for driving the pointer to point to the direction of the destination, thus the users can intuitionally view the direction of the destination at any moment, and the global positioning navigation system of the present invention is convenient and comfort in use.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a circuit block diagram of a human-machine interface apparatus in accordance with an exemplary embodiment of the present invention.

FIG. 1B is a schematic view of a pointing module in accordance with an exemplary embodiment of the present invention.

FIG. 2 is a circuit block diagram of a human-machine interface apparatus in accordance with another exemplary embodiment of the present invention.

FIG. 3 is a circuit block diagram of a human-machine interface apparatus in accordance with other exemplary embodiment of the present invention.

### DETAILED DESCRIPTION

Reference will now be made to the drawings to describe exemplary embodiments of the present human-machine interface apparatus, in detail. The following description is given by way of example, and not limitation.

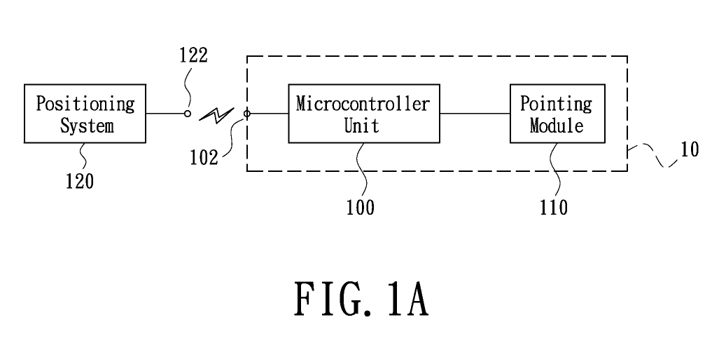

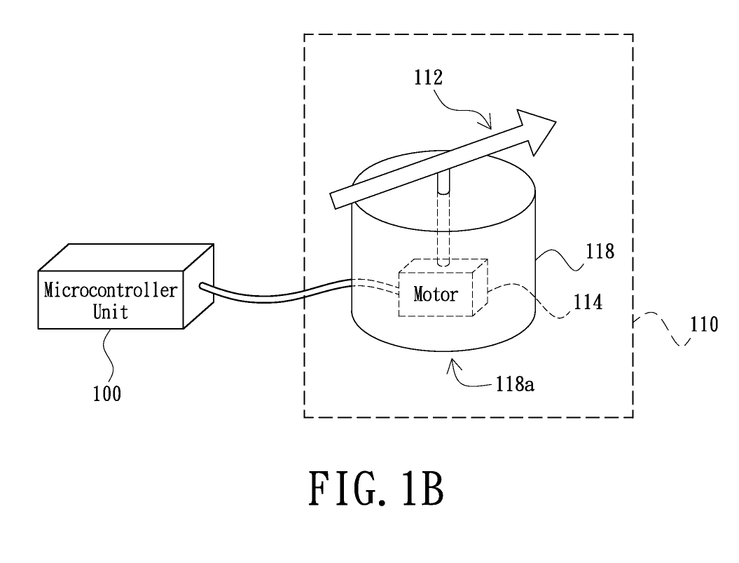

Refer to FIG. 1A, which is a circuit block diagram of a human-machine interface apparatus 10 in accordance with an exemplary embodiment of the present invention. In this exemplary embodiment, the human-machine interface apparatus 10 includes a microcontroller unit 100 and a pointing module 110. The microcontroller unit 100 employs a communication terminal 102 to receive data from a corresponding communication terminal 122 of a positioning system 120 (the communication terminals 102 and 122 are communicated with each other to transmit information by a wired mode or a wireless mode). In a general using state, users can set a destination which should be reached in the positioning system 120 in advance, and start performing a navigation function of the positioning system 120 after setting the destination. The microcontroller unit 100 obtains information of a target in relation to the navigation from the positioning system 120 at definite time or at indefinite time, such as positions of navigation relay stations, a position of the destination or a current position of the human-machine interface apparatus 10, etc. After obtaining the information of the targets, the microcontroller unit 100 can control the pointing module 110 electrically connected therewith, thus the pointing module 110 points to a suitable position.

Refer to FIG. 1B, which mainly illustrates a structure of the pointing module 110 in accordance with an exemplary embodiment of the present invention. In this exemplary embodiment, the pointing module 110 includes a main-body cover 118, a pointer 112 and a motor 114. The microcontroller 100 can control the motor 114 to change a direction indicated by the pointer 112. In addition, the pointing module 110 can be fixed at a position which is prone to be viewed by the users via a fixed mechanism, such as an attach device or a clamp device, which is assembled on a fixed portion of the pointing module 110 (such as a bottom 118a of the cover 118, or other places thereof).

In summary, since the human-machine interface apparatus 10 has a simple structure and does not include complicated and expensive circuits, such as the positioning system 120, etc., a size thereof can be effectively decreased and a cost thereof can be greatly decreased compared with the conventional positioning system. Therefore, the users will be not afraid of damaging the expensive navigation systems and will not limit the using modes of the navigation systems. For example, the conventional navigation systems are carefully assembled in the vehicle in general, but if employing the human-machine interface apparatus of the present invention, the users can place the positioning system 120 at any position where the positioning system 120 may transmit signals to the human-machine interface apparatus 10, and can freely employ the human-machine interface apparatus to perform the navigation operation. For example, the users can place the positioning system 120 in a pack and place the human-machine interface apparatus 10 on a handle of a bicycle, and do not worry about damaging expensive components. On the other hand, when the above human-machine interface apparatus 10 is employed to perform the navigation operation, it can perform the navigation operation without displaying a corresponding map. Thus the human-machine interface apparatus 10 can omit the components which have high costs and occupy more spaces, such as a display device, and the users can be prone to employ the navigation function at any condition.

In addition, although the microcontroller unit 100 is arranged out of the pointing module 110 in the exemplary embodiment as shown in FIGS. 1A and 1B, but it is obvious for that skilled in the art that the microcontroller unit 100 may be arranged in the pointing module 110 (such as, being contained by the cover 118), thus the related operation in setup can be simplified. Furthermore, the microcontroller unit 100 can be communicated with the pointing module 110 by the wired mode as same as the above exemplary embodiment. Alternatively, they also can be communicated with each other by the wireless mode.

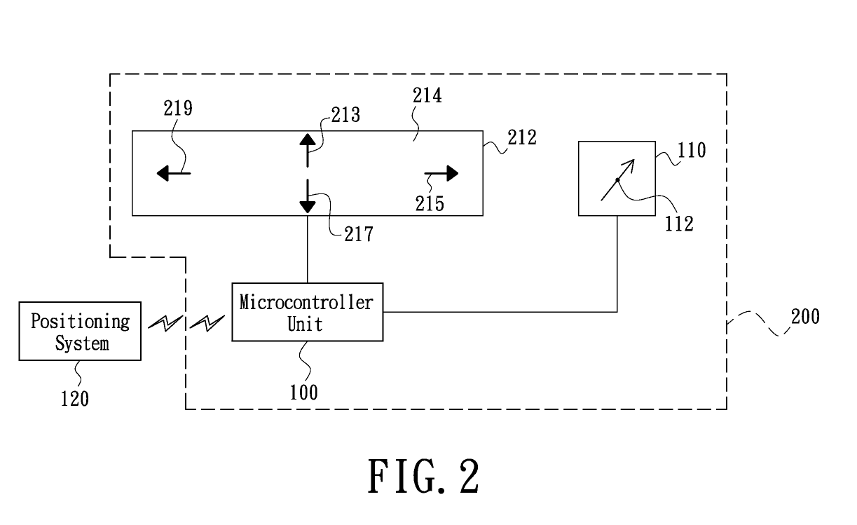

Refer to FIG. 2 next, which illustrates a human-machine interface apparatus 200 in accordance with another exemplary embodiment of the present invention. The human-machine interface apparatus 200 is similar to the human-machine interface apparatus 10 of the above exemplary embodiment, except that the human-machine interface apparatus 200 further includes an indicator-lamp module 212. The indicator-lamp module 212 is electrically connected with the microcontroller unit 100 and includes a plurality of directional indicators 213, 215, 217 and 219 and a light-penetrating plate 214. Preferably, the directional indicators 213, 215, 217 and 219 are light-emitting diodes, thus they can consume less power. The light-penetrating plate 214 has arrowheads printed thereon and covers the directional indicators 213, 215, 217 and 219, thus the light-penetrating plate 214 is prone to be disassembled when repairing or replacing the directional indicators. Of course, the indicator-lamp module 212 also can include a fixed portion, and the fixed portion may be an attaché device or a clamp device (not shown in FIG. 2), to fix the indicator-lamp module 212 on some positions of a vehicle, such as on an instrument panel or a sun visor.

The directional indicators 213, 215, 217 and 219 are configured for sending out instant navigation commands to a driver. For example, if the vehicle needs to turn at right or selects a right road, the directional indicator 215 twinkles. If the vehicle needs to decelerate or stop, the directional indicator 217 twinkles. If there is a condition which should be especially noted (such as a place in road-works, a dot for measuring speeds, etc), the directional indicator 213 twinkles. It can be understood that the amount and the detailed meanings of the directional indicators are not limited to be those of this exemplary embodiment, and they may be defined according to actual needs.

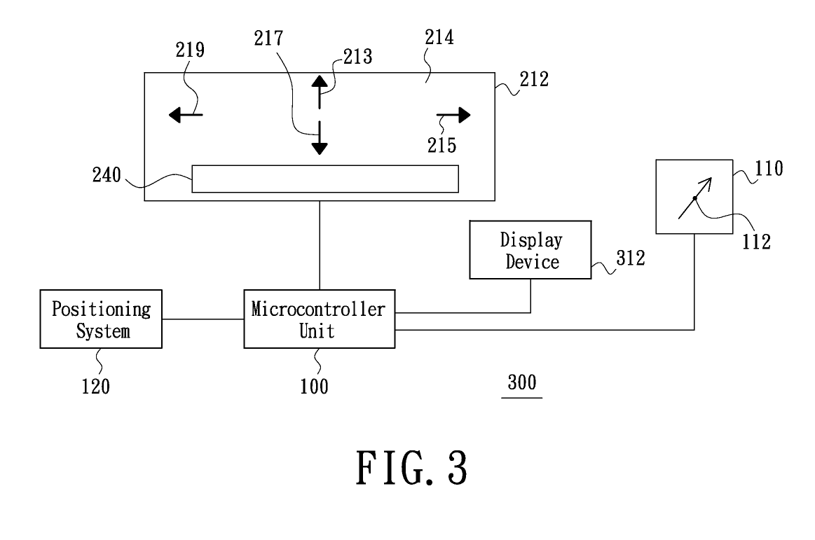

Refer to FIG. 3, which illustrates a human-machine interface apparatus 300 in accordance with other exemplary embodiment of the present invention. In this exemplary embodiment, the positioning system 120 is also arranged in the human-machine interface apparatus 300. In addition, the human-machine interface apparatus 300 further includes a display device 312, and the above indicator-lamp module 212 further includes a horse-race lamp 240 arranged therein. The display device 312 may be a liquid crystal display (LCD) device or a other-type display device, and may be installed in a position of a vehicle where is prone to be viewed by the users, such as being installed on an instrument panel or being hung adjacent to an invert goggle. The display device 312 may be configured for displaying accessorial information in relation to the road, the direction, and the destination. When being safe and convenient, the users can read these information in the display device 312. The horse-race lamp 240 also can provide some extra information. For example, when the microcontroller unit 100 controls the pointer 112 to point to the target which should be noted, or when the indicator-lamp module 212 twinkles to give an alert, the horse-race lamp 240 can provide some corresponding literal information to be a reference to the users. The target which should be noted, include navigation relay stations before reaching the actual position of the destination, road signs, places where traffic conditions happen, and positions of predetermined objects which should be noted by the users.

It should be noted that, the pointer 112 is not limited to point to the target or the navigation relay stations according to the description of the above exemplary embodiments. In other words, when the microcontroller unit 110 receives the information in relation to the target which should be noted from the positioning system, the microcontroller unit 110 can control the pointer 112 to rotate toward the targets which should be noted. Thus the visual lines of the driver are guided to rotate toward the targets which should be noted.

In addition, in this exemplary embodiment, since the human-machine interface apparatus 300 includes the expensive positioning system 120 and the display device 312 occupying a more space, the human-machine interface apparatus 300 has a high cost and occupies a more space. However, the human-machine interface apparatus 300 employs the definite pointer to perform the pointing operation, thus it can provide an intuitional and convenient navigation function.

From another point of view, the conventional human-machine interface apparatuses for the navigation mostly only provide the navigation function in the roads, but they cannot point to the actual position of a target after reaching the destination. Thus, preferably, the microcontroller unit 100 of the above exemplary embodiments can keep obtaining various data from the positioning system 120, thus the pointer may still keep pointing to the actual position of the predetermined target after reaching the navigation destination. Therefore it will decrease the inconvenience of looking about the actual position of the target after reaching the destination.

The human-machine interface apparatus 10, 200 and 300 disclosed in the above exemplary embodiments also can additionally include a built-in power supply to provide an inner power except for employing a vehicle-mounted power supply to provide an outer power. The built-in power supply may be a dry battery, a rechargeable battery, a solar battery, a fuel battery, or a biomass battery, etc. In addition, the elements of the above exemplary embodiments may be manufactured and assembled separately; alternatively, they may be partly or wholly integrated in a device. Various manufacturing designs may be altered in actual needs. The above exemplary embodiments are only given by way of examples, and are not configured for limiting the relation of the elements of the present invention.

Furthermore, although the above exemplary embodiments employ the actual pointer to perform the pointing function, the actual pointer may be replaced by other elements having the same function. For example, some common electrical light-emitting elements, such as light-emitting diodes (LEDs) or cold-light printing lamps, can obtain the same function. The electrical light-emitting elements may be driven by a conventional circuit, and it will not be described herein.

In summary, the above exemplary embodiments employ the microcontroller unit to drive the pointer to point to the direction of the target, thus the users can intuitionally view the pointer configured for pointing to the direction of the target at any moment. Therefore the global positioning navigation system of the present invention is convenient and comfort in use.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A human-machine interface apparatus configured for providing navigation information to users according to data from a positioning system, the human-machine interface apparatus comprising:
a pointing module having a pointer; and
a microcontroller unit configured for receiving information of a destination generated from the positioning system, the microcontroller unit being electrically connected with the pointing module and being configured for controlling the pointing module according to the information of the destination, to keep the pointer pointing to an actual position of the destination after a navigation is ended.

2. The human-machine interface apparatus as claimed in claim 1, further comprising a power supply configured for providing a power to the human-machine interface apparatus, wherein the power supply is selected from a group consisting of a dry battery, a rechargeable battery, a solar battery, a fuel battery and a biomass battery.

3. The human-machine interface apparatus as claimed in claim 1, further comprising an indicator-lamp module, wherein the indicator-lamp module is electrically connected with the microcontroller unit and comprises a plurality of directional indicators and a light-penetrating plate, and the light-penetrating plate covers the directional indicators.

4. The human-machine interface apparatus as claimed in claim 3, wherein the directional indicators are light-emitting diodes.

5. The human-machine interface apparatus as claimed in claim 3, wherein the light-penetrating plate has arrowheads printed thereon.

6. The human-machine interface apparatus as claimed in claim 3, wherein the indicator-lamp module further comprises a fixed portion to fix the indicator-lamp module.

7. The human-machine interface apparatus as claimed in claim 1, further comprising a display device electrically connected with the microcontroller unit.

8. The human-machine interface apparatus as claimed in claim 1, wherein the pointing module further comprises a motor, and the motor is controlled by the microcontroller unit to drive the pointer.

9. The human-machine interface apparatus as claimed in claim 1, wherein the pointing module further comprises a fixed portion to fix the pointing module.

10. The human-machine interface apparatus as claimed in claim 1, wherein the microcontroller unit further controls the pointer to point to a target which should be noted, the target comprises at least one of navigation relay stations before reaching the actual position of the destination, road signs, places where traffic conditions happen, and positions of predetermined objects which should be noted by the users.

11. A human-machine interface apparatus configured for providing navigation information to users according to data from a positioning system, the human-machine interface apparatus comprising:
a pointing module having a pointer; and
a microcontroller unit electrically connected with the pointing module, the microcontroller unit being configured for receiving information of a destination, and controlling the pointing module according to the information of the destination, to only employ the pointer of the pointing module to perform a navigation operation without displaying a corresponding map.

12. The human-machine interface apparatus as claimed in claim 11, further comprising a power supply configured for providing a power to the human-machine interface apparatus, wherein the power supply is selected from a group consisting of a dry battery, a rechargeable battery, a solar battery, a fuel battery and a biomass battery.

13. The human-machine interface apparatus as claimed in claim 11, further comprising an indicator-lamp module, wherein the indicator-lamp module is electrically connected with the microcontroller unit and comprises a plurality of directional indicators and a light-penetrating plate, and the light-penetrating plate covers the directional indicators.

14. The human-machine interface apparatus as claimed in claim 13, wherein the directional indicators are light-emitting diodes.

15. The human-machine interface apparatus as claimed in claim 13, wherein the light-penetrating plate has arrowheads printed thereon.

16. The human-machine interface apparatus as claimed in claim 13, wherein the indicator-lamp module further comprises a fixed portion to fix the indicator-lamp module.

17. The human-machine interface apparatus as claimed in claim 11, wherein the pointing module further comprises a motor, and the motor is controlled by the microcontroller unit to drive the pointer.

18. The human-machine interface apparatus as claimed in claim 11, wherein the pointing module further comprises a fixed portion to fix the pointing module.

19. The human-machine interface apparatus as claimed in claim 11, wherein the microcontroller unit further controls the pointer to point to a target which should be noted, the target comprises at least one of navigation relay stations before reaching an actual position of the destination, road signs, places where traffic conditions happen, and positions of predetermined objects which should be noted by the users.

20. A human-machine interface apparatus configured for providing navigation information to users according to data from a positioning system, the human-machine interface apparatus comprising:
a pointing module having a pointer; and
a microcontroller unit configured for receiving information generated from the positioning system, the microcontroller unit being electrically connected with the pointer module and being configured for controlling the pointing module according to the information to guide a direction of visual lines of a driver.

21. The human-machine interface apparatus as claimed in claim 20, wherein the microcontroller unit controls the pointer to point to a target which should be noted according to the information, and the target comprises at least one of navigation relay stations before reaching an actual position of the destination, road signs, places where traffic conditions happen, and positions of predetermined objects which should be noted by the users.
